(19) United States
(12) Patent Application Publication
(10) Pub. No.: US 2022/0195271 A1
(43) Pub. Date: Jun. 23, 2022

(54) SILICONE-BASED ADHESIVE PROTECTION FILM AND OPTICAL MEMBER COMPRISING SAME

(71) Applicant: SAMSUNG SDI CO., LTD., Yongin-si Gyeonggi-do (KR)

(72) Inventors: Dong Il HAN, Suwon-si (KR); Irina NAM, Suwon-si (KR); Won KIM, Suwon-si (KR); Hyun Seung KIM, Suwon-si (KR); Il Jin KIM, Suwon-si (KR)

(21) Appl. No.: 17/594,905

(22) PCT Filed: May 8, 2020
(86) PCT No.: PCT/KR2020/006122

§ 371 Date: Nov. 2, 2021

(30) Foreign Application Priority Data
May 9, 2019 (KR) 10-2019-0054556

(51) Int. Cl. C09J 183/04; C09J 11/06; C09J 7/30; G02B 1/14

(52) U.S. Cl. CPC C09J 183/04; C09J 11/06; C09J 2301/312; G02B 1/14; C09J 7/30

(57) ABSTRACT

Provided are a silicone-based adhesive protection film and an optical member comprising same, the silicone-based adhesive protective film being formed of a composition comprising an alkenyl group-containing organic polysiloxane mixture and a crosslinker, wherein the alkenyl group-containing organic polysiloxane mixture contains a mixture of component (i) and component (ii) and the crosslinker contains polysiloxane having SiH groups at both ends of the molecule. The silicone-based adhesive protection film has an elongation rate of 80% or more.

### TECHNICAL FIELD

The present invention relates to a silicone-based adhesive protective film and an optical member comprising the same.

### BACKGROUND ART

The use, storage and manufacturing environments of optical displays are becoming harsh. In addition, interest in new optical displays, such as wearable devices, foldable devices, and the like, is also increasing. As a result, an adhesive protective film for protecting an optical display panel is required to have various properties.

An adhesive protective film is attached to an adherend to protect the adherend. A stack of the adherend and the adhesive protective film is cut to a suitable size for the adherend in an optical display, followed by removing the adhesive protective film from the adherend. Since the adhesive protective film is attached to the adherend to protect the adherend and then is peeled off thereof, peel strength of the adhesive protective film to the adherend is an important issue. However, since the cutting process is essential in manufacture of the optical display, scattering of the adhesive protective film in the course of cutting the stack can cause damage to the adherend or can obstruct manufacture of a desired optical display. Therefore, there is a need for an adhesive protective film that has improved scattering characteristics by generating fewer scattering particles upon cutting after attachment to an adherend.

The background technique of the present invention is disclosed in Korean Patent Laid-open Publication No. 2012-0050136 and the like.

### DISCLOSURE

### Technical Problem

It is one aspect of the present invention to provide a silicone-based adhesive protective film that has improved scattering characteristics upon cutting after attachment to an adherend.

It is another aspect of the present invention to provide a silicone-based adhesive protective film that has good effects in protection of an adherend, a low peel strength increase rate, good wettability, and good step embedding properties.

It is a further aspect of the present invention to provide a silicone-based adhesive protective film that can prevent contamination of and damage to an adherend upon removal of the adhesive protective film from the adherend.

### Technical Solution

One aspect of the present invention relates to a silicone-based adhesive protective film.

1. The silicone-based adhesive protective film is formed of a composition including an alkenyl group-containing organic polysiloxane mixture and a crosslinking agent, wherein the alkenyl group-containing organic polysiloxane mixture includes a mixture of a component (i) and a component (ii):

Component (i): an organic polysiloxane having at least one silicon-bonded C₃ to C₁₀ alkenyl group per molecule,

Component (ii): an organic polysiloxane having at least one silicon-bonded vinyl group per molecule, and

the crosslinking agent includes a polysiloxane having a SiH group at both ends thereof, the silicone-based adhesive protective film having an elongation of 80% or more.

2. In 1, the silicone-based adhesive protective film may have a tensile strength of 5 MPa or less.

3. In 1 and 2, the C₃ to C₁₀ alkenyl group of the component (i) may be a hexenyl group.

4. In 3, the hexenyl group may be a 5-hexenyl group.

5. In 1 to 4, the component (i) may include an organic polysiloxane represented by Formula 1:

(R¹R²SiO_{2/2})ₓ(R³R⁴SiO_{2/2})_{y} [Formula 1]

where

R¹ is a C₃ to C₁₀ alkenyl group;

R² is a C₁ to C₁₀ alkyl group;

R³ and R⁴ are each independently a C₁ to C₁₀ alkyl group; and

0<x≤1, 0≤y<1, and x+y=1.

6. In 1 to 5, the component (ii) may further include a silicon-bonded aromatic group per molecule.

7. In 1 to 6, the component (ii) may include an organic polysiloxane presented by Formula 2:

(R¹R²SiO_{2/2})ₓ(R³R⁴SiO_{2/2})_{y}(R⁵R⁶SiO_{2/2})_{z} [Formula 2]

where

R¹, R², R³, R⁴, R⁵, and R⁶ are each independently a C₁ to C₁₀ alkyl group, a vinyl group, or a C₆ to C₁₀ aryl group,

at least one of R¹ and R² being a vinyl group; and

0<x≤1, 0≤y<1, 0≤z<1, and x+y+z=1.

8. In 1 to 7, in Formula 2, 0<y<1 and at least one of R³ and R⁴ may be a C₆ to C₁₀ aryl group.

9. In 1 to 8, the component (ii) may further include an organic polysiloxane having at least two silicon-bonded vinyl groups (Si-Vi) at both ends thereof.

10. In 1 to 9, the component (i) may be present in an amount of 1 part by weight to 80 parts by weight and the component (ii) may be present in an amount of 20 parts by weight to 99 parts by weight relative to a total of 100 parts by weight of the component (i) and the component (ii).

11. In 1 to 10, the crosslinking agent may be represented by Formula 5:

R⁵R⁶R⁷SiO(R¹R²SiO_{2/2})ₓ(R³R⁴SiO_{2/2})_{y}SiR⁸R⁹R¹⁰, [Formula 5]

where

R¹, R², R³, R⁴ are each independently a C₁ to C₁₀ alkyl group;

R⁵, R⁶, R⁷, R¹, R⁹, and R¹⁰ are each independently hydrogen or a C₁ to C₁₀ alkyl group,

at least one of R⁵, R⁶, and R⁷ being hydrogen,

at least one of R⁸, R⁹, and R¹⁰ being hydrogen; and

0≤x<1, 0<y≤1, and x+y=1.

12. In 1 to 11, the crosslinking agent may be present in an amount of 1 part by weight to 10 parts by weight relative to 100 parts by weight of the alkenyl group-containing organic polysiloxane mixture.

13. In 1 to 12, the composition may further include an organic polysiloxane resin,

the organic polysiloxane resin comprising at least one of component (iii) and component (iv):

component (iii): an organic polysiloxane resin including an R¹R²R³SiO_{1/2} unit (R¹, R², and R³ are each independently a C₁ to C₆ alkyl group)(M unit) and a SiO_{4/2} unit (Q unit);

component (iv): an organic polysiloxane resin including an R⁴R⁵R⁶SiO_{1/2} unit (R⁴, R⁵, and R⁶ being each independently a C₁ to C₆ alkyl group or a C₂ to C₁₀ alkenyl group, at least one of R⁴, R⁵ and R⁶ being a C₂ to C₁₀ alkenyl group) (M unit) and a SiO_{4/2} unit (Q unit).

14. In 1 to 13, the composition may further include a hydrosilylation catalyst.

Another aspect of the present invention relates to an optical member including an optical film and the silicone-based adhesive protective film according to the present invention formed on one surface of the optical film.

### Advantageous Effects

The present invention provides a silicone-based adhesive protective film that has improved scattering characteristics upon cutting after attachment to an adherend.

The present invention provides a silicone-based adhesive protective film that has good effects in protection of an adherend, a low peel strength increase rate, good wettability, and good step embedding properties.

The present invention provides a silicone-based adhesive protective film that can prevent contamination of and damage to an adherend upon removal of the adhesive protective film from the adherend.

### BRIEF DESCRIPTION OF DRAWINGS

FIG. 1 is a plan view of a specimen for measurement of tensile strength and elongation of a silicone-based adhesive protective film in examples.

### BEST MODE

Hereinafter, embodiments of the present invention will be described in detail with reference to the accompanying drawings. However, it should be understood that the present invention is not limited to the following embodiments and may be embodied in different ways. The following embodiments are provided to provide a thorough understanding of the invention to those skilled in the art.

Herein, “C₃ to C₁₀ alkenyl group” is a C₃ to C₁₀ mono-alkenyl group, for example, a propylene group, a butenyl group, a pentenyl group, a hexenyl group, a heptenyl group, an octenyl group, a nonenyl group, or a decenyl group.

Herein, in the “C₃ to C₁₀ alkenyl group”, the alkenyl group may be bonded to silicon in an organic polysiloxane to be placed at a distal end thereof.

Herein, “hexenyl group” (Hex) may be a 1-hexenyl group, a 2-hexenyl group, a 3-hexenyl group, a 4-hexenyl group, or a 5-hexenyl group. Preferably, the hexenyl group is a 5-hexenyl group (*—(CH₂)₄—CH═CH₂, * being a linking site to silicon).

Herein, “vinyl group” (Vi) means *—CH═CH₂ (* being a linking site).

Herein, “Ph” may be a phenyl group.

Herein, “adherend” may include a glass plate or a plastic film, such as a polyimide film or an acryl film, an acryl plate, and the like. Preferably, the adherend is a glass plate, a polyimide film, or an acryl film.

Herein, “peel strength” may be measured under conditions of a peeling speed of 2,400 mm/min, a peeling angle of 180°, and a peeling temperature of 25° C. using a tensile strength tester in accordance with JISZ2037.

Herein, “elongation” means a fracture elongation and is measured in accordance with ASTM D882.

Herein, “tensile strength” is a value measured in accordance with ASTM D882.

As used herein to represent a specific numerical range, “X to Y” means a value greater than or equal to X and less than or equal to Y (X≤ and ≤Y).

The inventors of the present invention developed a silicone-based adhesive protective film using a composition including an alkenyl group-containing organic polysiloxane mixture and a crosslinking agent, which includes a polysiloxane having a SiH group at both ends thereof.

According to the present invention, the silicone-based adhesive protective film has an elongation of 80% or more and thus achieves significant reduction in the number or amount of particles and/or foreign matter scattered upon cutting a stack of the silicone-based adhesive protective film and an adherend after attachment of the silicone-based adhesive protective film to the adherend, thereby significantly improving processability upon cutting the stack through improvement in scattering characteristics upon cutting the stack of the silicone-based adhesive protective film and the adherend.

Specifically, the silicone-based adhesive protective film may have an elongation of 80% to 200%, more specifically 90% to 180%.

The silicone-based adhesive protective film may have a tensile strength of 5 MPa or less, specifically 0 MPa to 5 MPa, more specifically 0.5 MPa to 4 MPa. Within this range, the silicone-based adhesive protective film can improve step embedding properties.

In addition, the silicone-based adhesive protective film has good peel strength with respect to an adherend to provide good effects in protection of the adherend and allows less increase in peel strength over time in a state of being attached to the adherend, thereby providing good storage stability without deformation of and/or damage to the adherend upon removal of the silicone-based adhesive protective film from the adherend. In addition, the silicone-based adhesive protective film has good step embedding properties and/or wettability with respect to the adherend to prevent generation of bubbles when the silicone-based adhesive protective film is attached to the adherend, thereby providing good processability upon cutting a stack of the silicone-based adhesive protective film and the adherend. Further, the silicone-based adhesive protective film can prevent contamination of or damage to the adherend upon removal of the silicone-based adhesive protective film therefrom, thereby providing good processability.

Specifically, the silicone-based adhesive protective film may have a peel strength of 15 gf/inch or less with respect to an adherend, for example, 0 gf/inch to 15 gf/inch, greater than 0 gf/inch to less than 15 gf/inch. Within this range, the adhesive protective film has good effects in protection of the adherend.

Hereinafter, a silicone-based adhesive protective film according to one embodiment of the present invention will be described.

The silicone-based adhesive protective film is formed of a composition including an alkenyl group-containing organic polysiloxane mixture and a crosslinking agent, wherein the alkenyl group-containing organic polysiloxane mixture includes a mixture of a component (i) and a component (ii):

component (i): an organic polysiloxane having at least one silicon-bonded C₃ to C₁₀ alkenyl group per molecule,

component (ii): an organic polysiloxane having at least one silicon-bonded vinyl group per molecule; and

wherein the crosslinking agent includes a polysiloxane having a SiH group at both ends thereof.

<Alkenyl Group-Containing Organic Polysiloxane Mixture>

The alkenyl group-containing organic polysiloxane mixture forms a matrix of the silicone-based adhesive protective film.

The alkenyl group-containing organic polysiloxane mixture includes the component (i) and the component (ii) to secure peel strength with respect to an adherend and can prevent deformation of and/or damage to the adherend by allowing easy removal of the silicone-based adhesive protective film from the adherend. In addition to the component (i) and the component (ii), the composition further includes the crosslinking agent described below.

In the composition according to the present invention, the alkenyl group-containing organic polysiloxane mixture including the component (i) alone without the component (ii) can cause deterioration in scattering characteristics and step embedding properties of the silicone-based adhesive protective film. In the composition according to the present invention, the alkenyl group-containing organic polysiloxane mixture including the component (ii) alone without the component (i) can cause increase in peel strength of the silicone-based adhesive protective film over time.

Component (i)

The component (i) serves to secure peel strength, a peel strength increase rate, and a residual peel strength variation rate of the silicone-based adhesive protective film by preventing excessive increase in peel strength of the silicone-based adhesive protective film together with the component (ii).

In the component (i), the C₃ to C₈ alkenyl group is preferably a hexenyl group, more preferably a 5-hexenyl group. The 5-hexenyl group is bonded to silicon in the organic polysiloxane and has an alkenyl group at a distal end from silicon to secure a rapid curing rate, thereby increasing curing density while reducing peel strength over time.

The component (i) is a linear, preferably straight, organic polysiloxane having at least one silicon-bonded C₃ to C₈ alkenyl group per molecule and may include at least one diorganosiloxane unit having a C₃ to C₁₀ alkenyl group.

For example, the component (i) may include an R¹R²SiO_{2/2} unit, where R¹ may be a C₃ to C₁₀ alkenyl group and R² may be a C₁ to C₁₀ alkyl group, for example, a methyl group, an ethyl group, or a propyl group.

The R¹R²SiO_{2/2} unit of the component (i) may be present in an amount of 0.01 mmol/g to 0.5 mmol/g, preferably 0.05 mmol/g to 0.3 mmol/g, in the organic polysiloxane. Within this range, the silicone-based adhesive protective film can have a suitable curing density.

In one embodiment, the component (i) may be an organic polysiloxane represented by Formula 1:

(R¹R²SiO_{2/2})ₓ(R³R⁴SiO_{2/2})_{y}, [Formula 1]

where

R¹ is a C₃ to C₁₀ alkenyl group;

R² is a C₁ to C₁₀ alkyl group;

R³ and R⁴ are each independently a C₁ to C₁₀ alkyl group; and

0<x≤1, 0≤y<1, and x+y=1.

In the organic polysiloxane of Formula 1, the R¹R²SiO_{2/2} unit may be present in an amount of 0.01 mmol/g to 0.5 mmol/g, preferably 0.05 mmol/g to 0.3 mmol/g. Within this range, the silicone-based adhesive protective film can have a suitable curing density.

Preferably, in Formula 1, x, y and z satisfy relations: 0<x<1, 0<y<1, and x+y=1, more preferably 0.0001≤x≤0.3 and 0.7≤y≤0.9999, still more preferably 0.01≤x≤0.3 and 0.7≤y≤0.99. Within this range, the silicone-based adhesive protective film can secure further improvement in step embedding properties and scattering characteristics.

The organic polysiloxane of Formula 1 or the component (i) may have a weight average molecular weight of 100,000 to 1,000,000, preferably 200,000 to 800,000. Within this range, the silicone-based adhesive protective film can have a suitable curing density and good wettability.

Preferably, in the organic polysiloxane mixture, the component (i) is a unary organic polysiloxane.

In one embodiment, the component (i) may include an organic polysiloxane including a Hex(CH₃)SiO_{2/2} unit and a (CH₃)₂SiO_{2/2} unit.

In one embodiment, the component (i) may include an organic polysiloxane consisting of the Hex(CH₃)SiO_{2/2} unit and the (CH₃)₂SiO_{2/2} unit.

In one embodiment, the component (i) may be free from a vinyl group-bonded siloxane unit, for example, a vinyl group-bonded dialkoxysilane, a vinyl group-bonded trialkoxysilane, or a vinyl group-bonded monoalkoxysilane.

In one embodiment, the component (i) may be free from a SiO_{4/2} unit (Q unit).

For example, the component (i) may be an end-capped organic polysiloxane represented by Formula 1-1:

R⁵R⁶R⁷SiO(R¹R²SiO_{2/2})ₓ(R³R⁴SiO_{2/2})_{y}SiR⁸R⁹R¹⁰, [Formula 1-1]

where

R¹ is a C₃ to C₁₀ alkenyl group;

R² is a C₁ to C₁₀ alkyl group;

R³ and R⁴ are each independently a C₁ to C₁₀ alkyl group;

R⁵, R⁶, R⁷, R⁸, R⁹ and R¹⁰ are each independently a C₁ to C₁₀ alkyl group; and

0<x≤1, 0≤y<1, and x+y=1.

Preferably, in Formula 1-1, x, y and z satisfy relations:0≤x≤1, 0≤y≤1, and x+y=1, preferably 0.0001≤x≤0.3 and 0.7≤y≤0.9999, more preferably 0.01≤x≤0.3 and 0.7≤y≤0.99. Within this range, the silicone-based adhesive protective film can secure further improvement in step embedding properties and scattering characteristics.

In one embodiment, the organic polysiloxane of Formula 1-1 may include an organic polysiloxane including (CH₃)₃SiO-(Hex(CH₃)SiO_{2/2})ₓ—((CH₃)₂SiO_{2/2})_{y}—Si(CH₃)₃.

The component (i) may be prepared through hydrolysis and condensation of an alkoxysilane providing an R¹R²SiO_{2/2} unit and an R³R⁴SiO_{2/2} unit by a method well known to those skilled in the art.

Relative to a total of 100 parts by weight of the alkenyl group-containing organic polysiloxane mixture or the mixture of the component (i) and the component (ii), the component (i) may be present in an amount of 1 part by weight to 80 parts by weight, preferably 1 part by weight to 60 parts by weight, more preferably 5 parts by weight to 50 parts by weight, most preferably 10 parts by weight to 30 parts by weight. Within this range, the silicone-based adhesive protective film can have good wettability while suppressing increase in peel strength over time.

Component (ii)

The component (ii) serves to increase peel strength of the silicone-based adhesive protective film together with the component (i) so as to secure peel strength of the present invention.

The component (ii) is a linear organic polysiloxane having at least one silicon-bonded vinyl group per molecule and may include at least one diorganosiloxane unit having a vinyl group.

The component (ii) may be free from a SiO_{4/2} unit (Q unit).

In one embodiment, the organic polysiloxane having at least one silicon-bonded vinyl group per molecule may include a linear, preferably straight, organic polysiloxane having at least one silicon-bonded vinyl group at a side chain thereof.

In one embodiment, the organic polysiloxane having at least one silicon-bonded vinyl group may include a linear, preferably straight, organic polysiloxane having at least one silicon-bonded aromatic group at a side chain.

In one embodiment, the organic polysiloxane having at least one silicon-bonded vinyl group may be free from a SiO_{4/2} unit (Q unit).

For example, the organic polysiloxane having at least one silicon-bonded vinyl group may include an organic polysiloxane represented by Formula 2:

(R¹R²SiO_{2/2})ₓ(R³R⁴SiO_{2/2})_{y}(R⁵R⁶SiO_{2/2})_{z}, [Formula 2]

where

R¹, R², R³, R⁴, R⁵ and R⁶ are each independently a C₁ to C₁₀ alkyl group, a vinyl group or a C₆ to C₁₀ aryl group,

at least one of R¹ and R² being a vinyl group, and

0<x≤1, 0≤y<1, 0≤z<1 and x+y+z=1.

In one embodiment, at least one of R¹ and R² may be a C₆ to C₁₀ aryl group or a C₁ to C₁₀ alkyl group.

In one embodiment, 0<y<1 and at least one of R³ and R⁴ may be a C₆ to C₁₀ aryl group.

In one embodiment, 0<z<1 and at least one of R⁵ and R⁶ may be a C₁ to C₁₀ alkyl group.

In one embodiment, in Formula 2, x, y and z may satisfy relations: 0<x<1, 0<y<1, 0<z<1, and x+y+z=1, preferably 0.001≤x≤0.05, 0.001≤y≤0.05, and 0.9≤z≤0.998. Within this range, the silicone-based adhesive protective film can secure further improvement in step embedding properties and scattering characteristics.

Preferably, the organic polysiloxane of Formula 2 may include at least one selected from among an organic polysiloxane including (Vi(CH₃)SiO_{2/2})ₓ—(Ph₂SiO_{2/2})_{y}—((CH₃)₂SiO_{2/2})_{z} and an organic polysiloxane including (Vi(CH₃)SiO_{2/2})ₓ—((CH₃)₂SiO_{2/2})_{z} (where x, y and z are the same as defined in Formula 2).

In one embodiment, the organic polysiloxane of Formula 2 may include an end-capped organic polysiloxane represented by Formula 2-1:

R⁷R⁸R⁹SiO(R¹R²SiO_{2/2})ₓ(R³R⁴SiO_{2/2})_{y}(R⁵R⁶SiO_{2/2})_{z}SiR¹⁰R¹¹R¹², [Formula 2-1]

where

R¹, R², R³, R⁴, R⁵ and R⁶ are each independently a C₁ to C₁₀ alkyl group, a vinyl group, or a C₆ to C₁₀ aryl group,

at least one of R¹ and R² being a vinyl group;

R⁷, R⁸, R⁹, R¹⁰, R¹¹ and R¹² are each independently a C₁ to C₁₀ alkyl group; and

0<x≤1, 0≤y<1, 0≤z<1, and x+y+z=1.

The component (ii) or the organic polysiloxane of Formula 2 may have a vinyl group equivalent weight of 0.01 mmol/g to 0.5 mmol/g, preferably 0.03 mmol/g to 0.3 mmol/g. Within this range, the silicone-based adhesive protective film can secure a suitable reaction rate and reactivity.

Preferably, the organic polysiloxane of Formula 2-1 includes at least one selected from among an organic polysiloxane including (CH₃)₃SiO—(Vi(CH₃)SiO_{2/2})ₓ—(Ph₂SiO_{2/2})_{y}—((CH₃)₂SiO_{2/2})_{z}—Si(CH₃)₃ and an organic polysiloxane including (CH₃)₃SiO—(Vi(CH₃)SiO_{2/2})ₓ—((CH₃)₂SiO_{2/2})_{z}—Si(CH₃)₃.

The component (ii) may further include an organic polysiloxane including at least two silicon-bonded vinyl groups (Si-Vi) at both ends thereof. The organic polysiloxane including at least two silicon-bonded vinyl groups (Si-Vi) at both ends thereof is a linear, preferably straight, organic polysiloxane and may include a diorganosiloxane unit.

In one embodiment, the linear organic polysiloxane including at least two silicon-bonded vinyl groups (Si-Vi) at both ends thereof may be free from a SiO_{4/2} unit (Q unit).

In one embodiment, the linear organic polysiloxane including at least two silicon-bonded vinyl groups (Si-Vi) at both ends thereof may include an organic polysiloxane represented by Formula 3:

R⁵R⁶R⁷SiO(R¹R²SiO_{2/2})ₓ(R³R⁴SiO_{2/2})_{y}SiR¹R⁹R¹⁰, [Formula 3]

where

R¹, R², R³ and R⁴ are each independently a C₁ to C₁₀ alkyl group;

R⁵, R⁶ and R⁷ are each independently a vinyl group or a C₁ to C₁₀ alkyl group,

at least one of R⁵, R⁶ and R⁷ being a vinyl group;

R¹, R⁹ and R¹⁰ are each independently a vinyl group or a C₁ to C₁₀ alkyl group,

at least one of R¹, R⁹ and R¹⁰ being a vinyl group; and

0≤x≤1, 0≤y≤1, and x+y=1.

The component (ii) or the organic polysiloxane of Formula 3 may have a vinyl group equivalent weight of 0.01 mmol/g to 0.5 mmol/g, preferably 0.05 mmol/g to 0.3 mmol/g. Within this range, the silicone-based adhesive protective film can have a suitable reaction rate and reactivity.

The component (ii) or the organic polysiloxane of Formula 3 may have a weight average molecular weight of 10,000 to 300,000, preferably 30,000 to 200,000. Within this range, the silicone-based adhesive protective film can have suitable reactivity.

In one embodiment, x, y and z satisfy relations: 0<x<1, 0<y<1, and x+y=1, preferably 0.0001≤x≤0.3 and 0.7≤y≤0.9999, more preferably 0.01≤x≤0.3 and 0.7≤y≤0.99. Within this range, the silicone-based adhesive protective film can secure further improvement in scattering characteristics and step embedding properties.

Preferably, the organic polysiloxane of Formula 3 may include an organic polysiloxane including Vi(CH₃)₂SiO—((CH₃)₂SiO_{2/2})ₙ—Si(CH₃)₂Vi (n being an integer of greater than 0 to 2,000).

Relative to a total of 100 parts by weight of the alkenyl group-containing organic polysiloxane mixture or the mixture of the component (i), the organic polysiloxane of Formula 2 and the organic polysiloxane of Formula 3, the component (i) may be present in an amount of 1 part by weight to 50 parts by weight, the organic polysiloxane of Formula 2 may be present in an amount of 1 part by weight to 95 parts by weight, and the organic polysiloxane of Formula 3 may be present in an amount of 1 part by weight to 50 parts by weight. Within this range, the silicone-based adhesive protective film can secure improvement in scattering characteristics and step embedding properties. Preferably, relative to a total of 100 parts by weight of the component (i), the organic polysiloxane of Formula 2 and the organic polysiloxane of Formula 3, the component (i) is present in an amount of 3 parts by weight to 30 parts by weight, the organic polysiloxane of Formula 2 is present in an amount of 40 parts by weight to 90 parts by weight, and the organic polysiloxane of Formula 3 is present in an amount of 2 parts by weight to 40 parts by weight.

The component (ii) may further include a linear organic polysiloxane including at least two silicon-bonded vinyl groups (Si-Vi) at a side chain. The linear, preferably straight, organic polysiloxane including at least two silicon-bonded vinyl groups (Si-Vi) at a side chain may include a diorganosiloxane unit.

In one embodiment, the linear organic polysiloxane including at least two silicon-bonded vinyl groups (Si-Vi) at a side chain may be free from a SiO_{4/2} unit (Q unit).

In one embodiment, the linear organic polysiloxane including at least two silicon-bonded vinyl groups (Si-Vi) at a side chain may include an organic polysiloxane represented by Formula 4:

(R¹R²SiO_{2/2})ₓ(R³R⁴SiO_{2/2})_{y}, [Formula 4]

where

R¹, R², R³ and R⁴ are each independently a C₁ to C₁₀ alkyl group or a vinyl group,

at least one of R¹ and R² being a vinyl group; and

0<x≤1, 0≤y<1, and x+y=1.

In one embodiment, the organic polysiloxane of Formula 4 may include an organic polysiloxane including (Vi(CH₃)SiO_{2/2})ₓ—((CH₃)₂SiO_{2/2})_{y}.

The component (ii) or the organic polysiloxane of Formula 4 may have a vinyl group equivalent weight of 0.01 mmol/g to 0.5 mmol/g, preferably 0.1 mmol/g to 0.3 mmol/g. Within this range, the silicone-based adhesive protective film can have a suitable reaction rate and reactivity.

The component (ii) or the organic polysiloxane of Formula 4 may have a weight average molecular weight of 50,000 to 200,000, preferably 100,000 to 150,000. Within this range, the silicone-based adhesive protective film can have a suitable curing density and wettability.

For example, the organic polysiloxane of Formula 4 may include an organic polysiloxane represented by Formula 4-1:

R⁵R⁶R⁷SiO(R¹R²SiO_{2/2})ₓ(R³R⁴SiO_{2/2})_{y}SiR¹R⁹R¹⁰, [Formula 4-1]

where

R¹, R², R³ and R⁴ are each independently a C₁ to C₁₀ alkyl group or a vinyl group,

at least one of R¹ and R² being a vinyl group;

R⁵, R⁶, R⁷, R⁸, R⁹ and R¹⁰ are each independently a C₁ to C₁₀ alkyl group; and

0<x≤1, 0≤y<1, and x+y=1.

In one embodiment, the organic polysiloxane of Formula 4-1 may include an organic polysiloxane including (CH₃)₃SiO—(Vi(CH₃)SiO_{2/2})ₓ—((CH₃)₂SiO_{2/2})_{y}—Si(CH₃)₃.

Relative to a total of 100 parts by weight of the alkenyl group-containing organic polysiloxane mixture or the mixture of the component (i) and the component (ii), the component (ii) may be present in an amount of 20 parts by weight to 99 parts by weight, preferably 40 parts by weight to 99 parts by weight, more preferably 50 parts by weight to 95 parts by weight, most preferably 70 parts by weight to 90 parts by weight. Within this range, the silicone-based adhesive protective film can have suitable initial peel strength and good wettability.

<Crosslinking Agent>

The crosslinking agent may include a hydrogen organopolysiloxane having two or more silicon-bonded hydrogen (Si—H) groups at both ends thereof. With the hydrogen organopolysiloxane having two or more silicon-bonded hydrogen (Si—H) groups at both ends thereof, the crosslinking reaction can further increase elongation of the silicone-based adhesive protective film upon crosslinking reaction with the alkenyl group-containing organic polysiloxane mixture.

The crosslinking agent may include a linear, preferably straight, hydrogen organopolysiloxane having two or more silicon-bonded hydrogen (Si—H) groups at both ends thereof.

In one embodiment, the crosslinking agent may be represented by Formula 5:

R⁵R⁶R⁷SiO(R¹R²SiO_{2/2})ₓ(R³R⁴SiO_{2/2})_{y}SiR¹R⁹R¹⁰, [Formula 5]

where

R¹, R², R³ and R⁴ are each independently a C₁ to C₁₀ alkyl group;

R⁵, R⁶, R⁷, R⁸, R⁹ and R¹⁰ are each independently hydrogen or a C₁ to C₁₀ alkyl group,

at least one of R⁵, R⁶ and R⁷ being hydrogen,

at least one of R¹, R⁹ and R¹⁰ being hydrogen; and

0≤x<1, 0<y≤1, and x+y=1.

In one embodiment, the crosslinking agent may be H(CH₃)₂SiO—[(CH₃)₂SiO_{2/2}]ₙ—Si(CH₃)₂H (n being an integer of greater than 0 to 2,000, for example, greater than 0 to 1,500, greater than 0 to 1,000, greater than 0 to 500).

The crosslinking agent may be present in an amount of 1 part by weight to 10 parts by weight, preferably 3 parts by weight to 10 parts by weight, relative to a total of 100 parts by weight of the alkenyl group-containing organic polysiloxane mixture or the mixture of the component (i) and the component (ii). Within this range, the crosslinking agent can secure elongation of the silicone-based adhesive protective film according to the present invention.

In one embodiment, the composition may be free from a hydrogen organopolysiloxane having at least one, preferably two or more, silicon-bonded hydrogen (Si—H) groups at a side chain thereof.

The composition for the silicone-based adhesive protective film may further include a hydrosilylation catalyst.

<Hydrosilylation Catalyst>

The hydrosilylation catalyst accelerates reaction between the organic polysiloxane and the crosslinking agent. The hydrosilylation catalyst may include a platinum catalyst, a ruthenium catalyst, or an osmium catalyst. Specifically, the hydro-silylation catalyst may include a typical platinum catalyst known to those skilled in the art. For example, the hydrosilylation catalyst may include chloroplatinic acid, an alcohol solution of chloroplatinic acid, a complex of chloroplatinic acid and olefin, a complex of chloroplatinic acid and alkenyl siloxane, and the like.

The hydrosilylation catalyst may be present in an amount of 0.1 parts by weight to 3 parts by weight, preferably 0.5 parts by weight to 2 parts by weight, relative to 100 parts by weight of the alkenyl group-containing organic polysiloxane mixture or the mixture of the component (i) and the component (ii). Within this range, the hydrosilylation catalyst can suppress peel strength variation over time.

The composition for the silicone-based adhesive protective film may further include an anchoring agent.

<Anchoring Agent>

The anchoring agent serves to further improve peel strength of the silicone-based adhesive protective film. The anchoring agent may include a typical siloxane compound known to those skilled in the art. The anchoring agent may include at least one selected from among vinyltriethoxysilane, allyltrimethoxysilane, allyltriethoxysilane, 3-glycidoxypropyltrimethoxysilane, and 3-(meth)acryloxypropyltrimethoxysilane, or may include an organic polysiloxane having a siloxane unit derived from any one of vinyltriethoxysilane, allyltrimethoxysilane, allyltriethoxysilane, 3-glycidoxypropyltrimethoxysilane, and 3-(meth)acryloxypropyltrimethoxysilane.

The anchoring agent may be present in an amount of less than 1 part by weight, specifically 0.05 parts by weight to less than 1 part by weight, preferably 0.1 parts by weight to 0.5 parts by weight, relative to 100 parts by weight of the alkenyl group-containing organic polysiloxane mixture or the mixture of the component (i) and the component (ii). Within this range, the anchoring agent can improve adhesion of the silicone-based adhesive protective film with respect to a base film.

The composition for the silicone-based adhesive protective film may further include an organic solvent to form a thin layer through improvement in coatability of the composition. The organic solvent may include toluene, xylene, hexane, heptane, and methyl ethyl ketone, without being limited thereto.

The composition for the silicone-based adhesive protective film may further include a hydrosilylation repressor. The hydrosilylation repressor serves to suppress reaction between the alkenyl group-containing organic polysiloxane mixture and the crosslinking agent and/or reaction between the mixture of the organic polysiloxane resin and the crosslinking agent to form a composition having target viscosity while improving storage stability. The hydrosilylation repressor may include a typical kind of hydrosilylation repressor known to those skilled in the art. For example, the hydrosilylation repressor may include 3-methyl-1-butine-1-ol and 3,5-dimethyl-1-butine-1-ol, without being limited thereto.

Next, a silicone-based adhesive protective film according to another embodiment of the invention will be described.

The silicone-based adhesive protective film according to this embodiment is formed of a composition that includes an alkenyl group-containing organic polysiloxane mixture, a crosslinking agent, and an organic polysiloxane resin, in which the crosslinking agent includes a polysiloxane having a SiH group at both ends thereof. The silicone-based adhesive protective film according to this embodiment is substantially the same as the silicone-based adhesive protective film according to the above embodiment excluding the organic polysiloxane resin. Hereinafter, the organic polysiloxane resin will be described.

<Organic Polysiloxane Resin>

In the silicone-based adhesive protective film, the organic polysiloxane resin serves to suppress increase in peel strength of the adhesive protective film over time while improving reliability.

The organic polysiloxane resin may include at least one selected from among a component (iii) and a component (iv). Preferably, the organic polysiloxane resin includes the component (iii) to secure elongation and tensile strength of the silicone-based adhesive protective film according to the present invention.

Component (iii): an organic polysiloxane resin including an R¹R²R³SiO_{1/2} unit (R¹, R², and R³ will be described in detail below) (M unit) and a SiO_{4/2} unit (Q unit).

Component (iv): an organic polysiloxane resin including an R⁴R⁵R⁶SiO_{1/2} unit (R⁴, R⁵, and R⁶ will be described in detail below) (M unit) and a SiO_{4/2} unit (Q unit).

The component (iii) is a non-reactive MQ resin.

The component (iv) is a reactive MQ resin.

Here, “reactivity” means reactivity with respect to the alkenyl group-containing organic polysiloxane.

In the R¹R²R³SiO_{1/2} unit, R¹, R² and R³ are each independently a C₁ to C₆ alkyl group, for example, a methyl group, an ethyl group, a propyl group, such as an isopropyl group and an N-propyl group, and the like.

In one embodiment, in the R¹R²R³SiO₂ unit, at least two or three of R¹, R² and R³ may be a methyl group.

In the component (iii) of the organic polysiloxane resin, the R¹R²R³SiO₂ unit and the SiO_{4/2} unit may be present in a mole ratio (R¹R²R³SiO_{1/2} unit:SiO_{4/2} unit) of 0.5:1 to 1.5:1, preferably 0.7:1 to 1.3:1. Within this range, the organic polysiloxane resin can increase initial peel strength of the adhesive film. Here, “mole ratio” may be calculated based on an area ratio between the SiO_{1/2} unit and the SiO_{4/2} unit obtained by measuring silicon NMR with respect to the silicone-based adhesive protective film, without being limited thereto.

In the R⁴R⁵R⁶SiO_{1/2} unit, R⁴, R⁵ and R⁶ are each independently a C₁ to C₆ alkyl group or a C₂ to C₁₀ alkenyl group, for example, a methyl group, an ethyl group, a propyl group, such as an isopropyl group and an N-propyl group, a vinyl group, or an allyl group, and at least one of R⁴, R⁵ and R⁶ may be a C₂ to C₁₀ alkenyl group.

In one embodiment, in the R⁴R⁵R⁶SiO_{1/2} unit, R⁴, R⁵ and R⁶ may be a vinyl group.

In the component (iv) of the organic polysiloxane resin, the R⁴R⁵R⁶SiO_{1/2} unit and the SiO_{4/2} unit may be present in a mole ratio (R⁴R⁵R⁶SiO_{1/2} unit:SiO_{4/2} unit) of 0.5:1 to 1.5:1, preferably 0.7:1 to 1.3:1. Within this range, the organic polysiloxane resin can increase curing density of the silicone-based adhesive protective film while securing suitable tensile strength thereof.

In the component (iv), the C₂ to C₁₀ alkenyl group of R⁴, R⁵ and R⁶ may be present in an amount of 0.1 mmol/g to 1.5 mmol/g, preferably 0.5 mmol/g to 1.0 mmol/g. Within this range, the silicone-based adhesive protective film can substantially suppress increase in peel strength over time.

The organic polysiloxane resin may be present in an amount of 0.01 parts by weight to 30 parts by weight, preferably 0.5 parts by weight to 25 parts by weight, more preferably 10 parts by weight to 20 parts by weight, relative to 100 parts by weight of the alkenyl group-containing organic polysiloxane mixture or the mixture of the component (i) and the component (ii). Within this range, the silicone-based adhesive protective film can have suitable initial peel strength and can suppress increase in peel strength over time.

In the composition, a weight ratio (R/P) of the organic polysiloxane resin to the total of the alkenyl group-containing organic polysiloxane and the crosslinking agent may be in the range of 0.01 to 1.5, preferably 0.02 to 1. Within this range, the silicone-based adhesive protective film can have suitable peel strength and can control peel strength variation over time.

The silicone-based adhesive protective film may have a haze of 5% or less, for example, 0% to 1%. Within this range, the silicone-based adhesive protective film can be applied to an optical display.

The silicone-based adhesive protective film may have a thickness of 100 μm or less, for example, 75 μm or less, greater than 0 μm to 75 μm. Within this thickness range, the silicone-based adhesive protective film can protect an adherend and can be easily removed from the adherend after attachment thereto.

The silicone-based adhesive protective film may be formed of the composition for the silicone-based adhesive protective film.

An optical member according to one embodiment includes an optical film and an adhesive protective film formed on at least one surface of the optical film, wherein the adhesive protective film may include the silicone-based adhesive protective film according to the embodiments of the present invention.

The optical film is a display panel and may include a polyimide film. In one embodiment, the optical film may include a light emitting element layer and a polyimide film formed on at least one surface of the light emitting element layer. An organic insulation layer or an inorganic insulation layer may be further formed between the optical film and the silicone-based adhesive protective film. The optical member may further include a release film (liner) on the other surface of the silicone-based adhesive protective film. The release film can prevent contamination of the adhesive protective film due to foreign matter and the like. As the release film, an optical film formed of the same material as or a different material from the aforementioned optical film may be used. For example, the release film may be formed of at least one resin selected from among a polyethylene terephthalate resin, a polycarbonate resin, a polyimide resin, a poly(meth)acrylate resin, a cyclic olefin polymer resin, and an acrylic resin. The release film may have a thickness of 10 μm to 100 μm, preferably 10 μm to 50 μm. Within this range, the release film can support the adhesive protective film.

### MODE FOR INVENTION

Next, the present invention will be described in more detail with reference to some examples. It should be understood that these examples are provided for illustration only and are not to be construed in any way as limiting the invention.

### Example 1

Components listed in Table 1 were mixed in amounts (unit: parts by weight) in terms of solid content, as listed in Table 1, and 10 parts by weight of toluene was further added as a solvent to the mixture, thereby preparing a composition for silicone-based adhesive protective films.

The prepared composition was deposited to a predetermined thickness on a release film (polyethylene terephthalate (PET) film, thickness: 75 m), dried at 80° C. for 2 minutes and at 130° C. for 3 minutes, and left at room temperature at 50° C. for 2 days, thereby preparing a stack of a silicone-based adhesive protective film (thickness: 75 m) and the release film.

### Examples 2 to 5

Each silicone-based adhesive protective film was prepared in the same manner as in Example 1 except that the kind and amount of each component of a composition for silicone-based adhesive protective films were changed as listed in Table 1.

### Comparative Examples 1 to 3

Each silicone-based adhesive protective film was prepared in the same manner as in Example 1 except that the kind and amount of each component of a composition for silicone-based adhesive protective films were changed as listed in Table 1.

The silicone-based adhesive protective films prepared in Examples and Comparative Examples were evaluated as to the following properties and results are shown in Table 1.

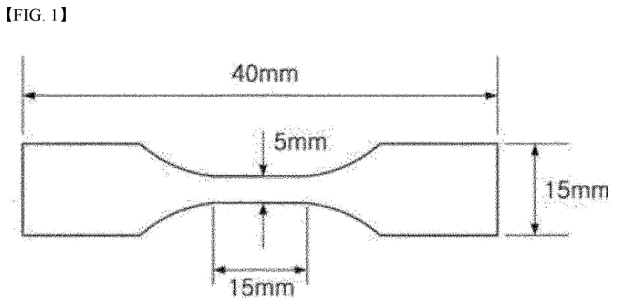

(1) Tensile strength (unit: MPa): The composition prepared in each of Examples and Comparative Examples was coated to a predetermined thickness on one surface of a fluorinated film (FL-75BML, Dongwon Intech Co., Ltd.) and a PET film was bonded to the coating layer and cured at 130° C. for 5 minutes, thereby preparing a stack in which a 75 m thick silicone-based adhesive protective film is interposed between the fluorinated film and the PET film. The stack was cut into a dog bone shape, as shown in FIG. 1, followed by removing the fluorinated film and the PET film therefrom, thereby preparing a specimen for measurement of tensile strength.

Referring to FIG. 1, the specimen has a dog bone shape having a total length of 40 mm, a total width of 15 mm, and a thickness of 75 μm. Tensile strength was measured with respect to the specimen for modulus measurement using a tensile strength tester (Instron Inc.). Specifically, the dog bone-shaped specimen shown in FIG. 1 was connected at a left end thereof to a first jig of the tester and at a right end thereof to a second jig thereof. Here, a connected portion of the left end to the first jig had the same area as a connected portion of the right end to the second jig. Then, tensile strength was measured by moving the second jig under conditions of a 1 kN load cell and a tensile speed of 50 mm/min at 25° C., with the first jig secured to the tester, until a portion of the dog bone-shaped specimen of FIG. 1 indicated by a width of 15 mm and a thickness of 5 mm was broken.

(2) Elongation (unit: %): A dog bone-shaped specimen was prepared in the same manner as in (1). Then, the prepared specimen was stretched at a cross-head speed of 50 mm/min and a temperature of 25° C. using a U.T.M in accordance with ASTM D882 until the prepared specimen fractured, followed by measurement of a final length of the specimen before fracture. Then, elongation of the specimen was calculated as follows. Here, the initial length of the specimen was 40 mm.

Elongation (%)=(Final length of the specimen stretched until the specimen fractured/Initial length of the specimen)×100

(3) Anti-scattering characteristics: Anti-scattering characteristics were evaluated on a coating layer of a silicone PSA film using a pensile hardness tester (CT-PC2, Core Tech Co., Ltd.) in accordance with JIS K5400. In evaluation of particle scattering, an SUS pen having a diameter of 1 mm was prepared and used. A scratch was made by moving the SUS pen across the surface of the coating layer under conditions of a load of 1 kg, a scratch angle of 45°, and a scratch speed of 48 mm/min. Evaluation of the anti-scattering characteristics was performed three times based on the presence or absence of particles observed through a microscope. Good indicates no generation of the particles.

TABLE 1

| | Example | | | | | Comparative Example | | |
|---|---|---|---|---|---|---|---|---|
| | 1 | 2 | 3 | 4 | 5 | 1 | 2 | 3 |
| 7654 | 10 | 10 | 10 | 10 | 10 | 10 | 10 | 100 |
| X-40-3306k | 80 | 80 | 80 | 80 | 90 | 80 | 90 | 0 |
| 7626 | 10 | 10 | 10 | 10 | 0 | 10 | 0 | 0 |
| Modifier 705 | 6.30 | 3.78 | 6.30 | 3.78 | 6.30 | 0 | 0 | 6.30 |
| 7028 | 0 | 0 | 0 | 0 | 0 | 0 | 6 | 0 |
| 7426 | 20 | 19.5 | 0 | 0 | 16.75 | 17.1 | 13.85 | 0 |
| CAT-PL-50T | 0.82 | 0.77 | 0.63 | 0.60 | 0.69 | 0.70 | 0.57 | 0.53 |
| R/P | 0.3 | 0.3 | — | — | 0.3 | 0.3 | 0.3 | — |
| Tensile | 2.35 | 2.67 | 1.8 | 1.9 | 3.5 | 6.2 | 7.4 | 3.0 |
| strength | | | | | | | | |
| Elongation | 151 | 130 | 130 | 125 | 142 | 60 | 50 | 25 |
| Anti- | Good | Good | Good | Good | Good | Particles | Particles | Particles |
| scattering | | | | | | generated | generated | generated |
| characteristics | | | | | | | | |

In Table 1, “R/P” means (content of 7426)/(total content of 7654, X-40-3306k, 7626, Modifier 705, and 7028) in the composition.
In Table 1, the content of the catalyst in the compositions of Examples and Comparative Example was 73 ppm.
Table 2 shows components used in Table 1.

TABLE 2

| Product | Classification | |
|---|---|---|
| Name | (Manufacturer) | Description |
| 7654 | Organic | Polysiloxane having dimethylsiloxane and |
| | polysiloxane | 5-hexenylmethylsiloxane, |
| | (Dow Corning) | End-capped with a trimethylsiloxy group |
| X-40- | Organic | Polysiloxane having diphenylsiloxane, |
| 3306K | polysiloxane | dimethylsiloxane and vinylmethylsiloxane, |
| | (Shin-Etsu) | End-capped with a trimethylsiloxy group |
| 7626 | Organic | Polysiloxane having dimethylsiloxane, |
| | polysiloxane | End-capped with a dimethylvinylsiloxy |
| | (Dow Corning) | group at both ends |
| Modifier | Crosslinking | Polysiloxane having SiH at both ends |
| 705 | agent | |
| | (Evonik) | |
| 7028 | Crosslinking | Methyl hydrogen polysiloxane, |
| | agent | End-capped with a trimethylsiloxy group |
| | (Dow Corning) | |
| 7426 | Organic | MQ resin having a (CH₃)₃SiO_{1/2} unit alone |
| | polysiloxane | as an M unit and a SiO_{4/2} unit |
| | resin | |
| | (Dow Corning) | |
| CAT-PL- | Hydrosilylation | Platinum catalyst |
| 50T | catalyst | |
| | (Shin-Etsu) | |

As shown in Table 1, the silicone-based adhesive protective films according to the present invention satisfied elongation and tensile strength conditions of the present invention and exhibited improvement in anti-scattering characteristics upon cutting after attachment to an adherend. Conversely, the silicone-based adhesive protective films of Comparative Examples 1 and 2 failed to satisfy the elongation and tensile strength conditions of the present invention and the silicone-based adhesive protective film of Comparative Example 3 failed to satisfy the elongation according to the present invention. The silicone-based adhesive protective films of the comparative examples exhibited poor anti-scattering characteristics and generated particles upon evaluation of the anti-scattering characteristics.

It should be understood that various modifications, changes, alterations, and equivalent embodiments can be made by those skilled in the art without departing from the spirit and scope of the present invention.

1. A silicone-based adhesive protective film formed of a composition comprising an alkenyl group-containing organic polysiloxane mixture and a crosslinking agent,
wherein the alkenyl group-containing organic polysiloxane mixture comprises a mixture of a component (i) and a component (ii):
Component (i): an organic polysiloxane having at least one silicon-bonded C₃ to C₁₀ alkenyl group per molecule,
Component (ii): an organic polysiloxane having at least one silicon-bonded vinyl group per molecule; and
the crosslinking agent comprises a polysiloxane having a SiH group at both ends thereof,
the silicone-based adhesive protective film having an elongation of 80% or more.

2. The silicone-based adhesive protective film according to claim 1, wherein the silicone-based adhesive protective film has a tensile strength of 5 MPa or less.

3. The silicone-based adhesive protective film according to claim 1, wherein the C₃ to C₁₀ alkenyl group of the component (i) is a hexenyl group.

4. The silicone-based adhesive protective film according to claim 3, wherein the hexenyl group is a 5-hexenyl group.

5. The silicone-based adhesive protective film according to claim 1, wherein the component (i) comprises an organic polysiloxane represented by Formula 1:
(R¹R²SiO_{2/2})ₓ(R³R⁴SiO_{2/2})_{y}, [Formula 1]
where R¹ is a C₃ to C₁₀ alkenyl group;
R² is a C₁ to C₁₀ alkyl group;
R³ and R⁴ are each independently a C₁ to C₁₀ alkyl group; and
0<x≤1, 0≤y<1, and x+y=1.

6. The silicone-based adhesive protective film according to claim 1, wherein the component (ii) further comprises a silicon-bonded aromatic group per molecule.

7. The silicone-based adhesive protective film according to claim 1, wherein the component (ii) comprises an organic polysiloxane presented by Formula 2:
(R¹R²SiO_{2/2})ₓ(R³R⁴SiO_{2/2})_{y}(R⁵R⁶SiO_{2/2})_{z}, [Formula 2]
where R¹, R², R³, R⁴, R⁵ and R⁶ are each independently a C₁ to C₁₀ alkyl group, a vinyl group, or a C₆ to C₁₀ aryl group,
at least one of R¹ and R² being a vinyl group; and
0<x≤1, 0≤y<1, 0≤z<1, and x+y+z=1.

8. The silicone-based adhesive protective film according to claim 7, wherein, in Formula 2, 0<y<1 and at least one of R³ and R⁴ is a C₆ to C₁₀ aryl group.

9. The silicone-based adhesive protective film according to claim 1, wherein the component (ii) further comprises an organic polysiloxane having at least two silicon-bonded vinyl groups (Si-Vi) at both ends thereof.

10. The silicone-based adhesive protective film according to claim 1, wherein the component (i) is present in an amount of 1 part by weight to 80 parts by weight and the component (ii) is present in an amount of 20 parts by weight to 99 parts by weight relative to a total of 100 parts by weight of the component (i) and the component (ii).

11. The silicone-based adhesive protective film according to claim 1, wherein the crosslinking agent is represented by Formula 5:
R⁵R⁶R⁷SiO(R¹R²SiO_{2/2})ₓ(R³R⁴SiO_{2/2})_{y}SiR⁸R⁹R¹⁰, [Formula 5]
where
R¹, R², R³ and R⁴ are each independently a C₁ to C₁₀ alkyl group;
R⁵, R⁶, R⁷, R⁸, R⁹ and R¹⁰ are each independently hydrogen or a C₁ to C₁₀ alkyl group,
at least one of R⁵, R⁶ and R⁷ being hydrogen,
at least one of R⁸, R⁹ and R¹⁰ being hydrogen; and
0≤x<1, 0<y≤1, and x+y=1.

12. The silicone-based adhesive protective film according to claim 1, wherein the crosslinking agent is present in an amount of 1 part by weight to 10 parts by weight relative to 100 parts by weight of the alkenyl group-containing organic polysiloxane mixture.

13. The silicone-based adhesive protective film according to claim 1, wherein the composition further comprises an organic polysiloxane resin,
the organic polysiloxane resin comprising at least one of component (iii) and component (iv):
component (iii): an organic polysiloxane resin comprising an R¹R²R³SiO_{1/2} unit (R¹, R² and R³ being each independently a C₁ to C₆ alkyl group) (M unit) and a SiO_{4/2} unit (Q unit),
component (iv): an organic polysiloxane resin comprising an R⁴R⁵R⁶SiO_{1/2} unit (R⁴, R⁵, and R⁶ being each independently a C₁ to C₆ alkyl group or a C₂ to C₁₀ alkenyl group, at least one of R⁴, R⁵ and R⁶ being a C₂ to C₁₀ alkenyl group) (M unit) and a SiO_{4/2} unit (Q unit).

14. The silicone-based adhesive protective film according to claim 1, wherein the composition further comprises a hydrosilylation catalyst.

15. An optical member comprising: an optical film; and the silicone-based adhesive protective film according to claim 1 formed on one surface of the optical film.
